(19) United States
(12) Patent Application Publication
(10) Pub. No.: US 2023/0111534 A1
(43) Pub. Date: Apr. 13, 2023

(54) Adjustable Infant Carrier

(71) Applicant: Silver Cross (IP) Limited, Skipton (GB)

(72) Inventors: Philip Jeffrey Taylor, Skipton (GB); John William Jennings, Leeds (GB)

(73) Assignee: Silver Cross (IP) Limited, Skipton (GB)

(21) Appl. No.: 18/045,617

(22) Filed: Oct. 11, 2022

(30) Foreign Application Priority Data
Oct. 12, 2021 (GB) 2114596.6

(51) Int. Cl. A47D 13/02; B62B 9/12

(52) U.S. Cl. CPC A47D 13/025; B62B 9/12

(57) ABSTRACT

There is provided an adjustable infant carrier comprising: a backrest for supporting the upper body of an infant, the backrest having a front side and a rear side; a support shaft arranged at the rear side of the backrest; a harness assembly comprising at least one plate member arranged on the front side of the backrest; and a releasable locking mechanism positioned between the at least one plate member and the support shaft, the releasable locking mechanism being connected to the at least one plate member and being configured to secure the position of the harness assembly relative to the support shaft and relative to the backrest; and wherein the at least one plate member and releasable locking mechanism are jointly slidably moveable relative to the support shaft and relative to the backrest.

### FIELD OF THE INVENTION

The present invention relates to infant carriers which are adjustable, such that a growing infant can be accommodated in the infant carrier of the present invention. The adjustable infant carrier according to the present invention avoids the need for several infant carriers, as a single adjustable infant carrier can be provided as the infant grows. The present invention also relates to a reversibly removable head rest for an infant carrier.

### BACKGROUND

In the early stages of development, infants grow rapidly and outgrow infant carriers which are typically intended for particular stages of development. For instance an infant carrier intended for a 0-6 month old infant is generally unsuitable for an infant who is 18-24 months old. In practice, this means the user is often faced with the problem of purchasing several infant carriers within a relatively short space of time (in the order of 6 months to 3 years). The need to buy several infant carriers can be costly for the user, and also is environmentally unfriendly as infant carriers may not be used again once the infant outgrows said infant carrier.

It would therefore be desirable to provide an infant carrier that is suitable for use with an infant from birth, up to 36 months old.

Adjustable infant carriers may comprise harnesses which may be adjustable. The height of the harness may be adjustable relative to the backrest of the infant carrier. However, these adjustable infant carrier require several moving components and complicated mechanisms. For example, an adjustable infant carrier may include a laterally arranged rod connected to a harness assembly, wherein the rod is moved up and down relative to the backrest to adjust the height of the harness. The rod is accessible from the rear of the infant carrier, and is secured in various positions by two or more racks of teeth provided on the backrest. This mechanism is bulky and requires several moving components. It also requires the user to use both hands when adjusting the harness assembly, which may not always be practical (e.g. when one hand is holding the infant carrier). It would therefore be advantageous to have a simpler, more user friendly mechanism for adjusting the height of a harness relative to the backrest of an infant carrier.

It is an object of the present invention to obviate or mitigate one or more of the above-mentioned problems.

### SUMMARY OF INVENTION

According to a first aspect of the present invention, there is provided an adjustable infant carrier comprising: a backrest for supporting the upper body of an infant, the backrest having a front side and a rear side; a support shaft arranged at the rear side of the backrest; a harness assembly comprising at least one plate member arranged on the front side of the backrest; and a releasable locking mechanism positioned between the at least one plate member and the support shaft, the releasable locking mechanism being connected to the at least one plate member and being configured to secure the position of the harness assembly relative to the support shaft and relative to the backrest; and wherein the at least one plate member and releasable locking mechanism are jointly slidably moveable relative to the support shaft and relative to the backrest.

It is desirable to provide an infant carrier that can be adjusted to take account of the growth of an infant. Existing adjustable infant carriers utilise a cross-bar which engages with a plurality of notches disposed on the backrest of the infant carrier. The cross-bar is resiliently positioned such that it can be moved out of a notch by means of a paddle positioned facing away from the backrest. In order to accommodate the paddles and cross bar, there is a large opening in the rear of the infant carrier. In addition, since the cross-bar is released by pulling a paddle upwards, it is less convenient to adjust the harness assembly downwardly with a single hand since the motion required to move the paddle is opposite to the direction the harness is to be moved in. The present invention provides the releasable locking mechanism between the plate member and the support shaft. As such the opening at the back of the carrier can be smaller and it is easier to operate with one hand.

The backrest may comprise at least one elongated aperture, wherein the releasable locking mechanism is slidably arranged in the at least one elongated aperture. The releasable locking mechanism may at least partially traverses the elongated aperture.

The support shaft may comprises an elongated recess, and the releasable locking mechanism may be slidably arranged in the elongated recess.

The support shaft may comprise a plurality of engagement means arranged along the length of the support shaft, optionally wherein the engagement means face the rear side of the back rest. By having the engagement means facing the rear side of the backrest, they are internal to the mechanism and more enclosed, so it is less likely that foreign objects or fingers will be trapped therein.

Each engagement means may correspond to a position in which the harness assembly may be secured by the releasable locking mechanism. As such, there may be three engagement means corresponding to three separate positions. It will be appreciated that there may be more than three engagement means resulting in the possibility of more positions.

Each engagement means may be a recess.

The releasable locking mechanism may comprise at least one locking member, wherein the at least one locking member is configured to engage with at least one of the plurality of engagement means.

The at least one locking member may have a complementary shape to each of the engagement means, optionally wherein the at least one locking member is a locking pin.

The releasable locking mechanism may further comprise a locking mechanism housing. The locking mechanism housing may substantially enclose the locking mechanism.

The locking mechanism housing may be connected to the at least one plate member.

The releasable locking mechanism may further comprise a locking release, wherein actuation of the locking release allows slidable movement of the releasable locking mechanism relative to the support shaft and relative to the backrest.

The at least one plate member comprises a harness plate member for securing a harness to the infant seat.

The harness plate may comprise a pair of apertures configured to reversibly secure harness securing means, optionally wherein the harness securing means may be connectors configured to snap fit into said apertures.

The harness securing means may be resiliently deformable, such that the harness securing means can be deformed into a releasing configuration to disengage the harness securing member from the apertures

The harness plate member may further support shoulder pad securing means

The harness plate member may comprise a pair of apertures configured to reversibly secure shoulder pad securing means, optionally wherein the should pad securing means snap fit into the apertures

The at least one plate member may comprises a headrest plate member for supporting the head of an infant.

The headrest plate may be reversibly connected to the infant seat.

The headrest plate may be reversibly connected to the infant seat by means of a plug and socket arrangement.

The headrest plate may comprise at least one plug portion. The at least one plug portion may comprise a female member, a biasing member, and a male member, wherein the male member comprises a recess such that the biasing member can be accommodated therein.

The biasing means may bias the male member within the female member into a locking position, and wherein relative movement between the male member and the female member against the biasing member provides a releasing position.

The male member may comprise a cam surface or a sloped surface.

The plug portion may comprise a release button, to allow the headrest plate to be removed.

The seat unit may comprise at least one socket portion, wherein the at least one socket portion comprises an asymmetrical aperture.

The asymmetrical aperture may comprise an upper portion and a lower portion, wherein the upper portion is larger than the lower portion.

In use, the at least one plug portion may be inserted into the upper portion, and then slidably moved into engagement with the lower portion.

The lower portion may comprise a locking protrusion, for engaging with the at least one plug portion of the headrest plate to lock the headrest plate in position. As such, the plug portion may be inserted in a horizontal direction into the upper portion. The plug portion may then be moved downwardly into the lower portion. The male member of the plug portion may engage with the locking protrusion of the lower portion. As the male member includes a sloped portion or a cam portion, continued downward movement of the plug portion pushes against the resiliently held male portion causing it to move in a direction perpendicular to the downward movement. This compresses the resilient member, preferably a spring, and allows the plug portion to engage with the lower portion. Once the sloped portion or cam portion has cleared the locking protrusion, the resilient member urges the male portion to return to its previous position. The upper surface of the male member does not include a cam or sloped surface. As such, if the male member is moved upwardly again, it is prevented from doing so by the locking member. In order to clear the locking member, it is necessary to manually compress the resilient member and then the plug portion can be moved vertically to clear the locking member and allow removal of the head rest. In this way, the headrest can be attached through two simple movements, namely insertion into the upper portion and then downward motion without the need to manually compress the resilient member, but requires the opposite movements coupled with manual compression of the resilient member in order to remove the headrest.

The at least one socket portion may transverse at least one further plate comprised in the harness assembly.

The at least one socket portion may extend into the backrest, wherein the backrest comprises a recess for accommodating the at least one socket portion.

The at least one plate member may comprise a base plate for supporting one or more further plate members.

The at least one plate member may comprise: a base plate member; a harness plate member for supporting harness straps for securing an infant to the seat, the harness plate member being arranged on the base plate member; and a reversibly connectable headrest plate member for supporting the head of an infant, the headrest plate member being reversibly attachable to at least the harness plate member.

The backrest may comprise at least one aperture, the at least one aperture providing access the harness assembly from the rear side of the backrest.

According to a second aspect of the invention, there is provided a headrest plate member for use with an infant carrier, wherein the headrest plate member is reversibly connectable to the infant carrier by means of a plug and socket arrangement, and comprises at least one plug portion, wherein the at least one plug portion comprises a female member, a biasing member, and a male member, wherein the male member comprises a recess such that the biasing member can be accommodated therein.

Advantageously the headrest plate member can be reversibly attached to an infant seat carrier, and conveniently comprises a plug portion which also acts as a locking mechanism, allowing the headrest plate member to be easily reversibly attached to the infant seat carrier. The headrest plate member may be as described herein with reference to the first aspect of the present invention.

### BRIEF DESCRIPTION OF FIGURES

The present invention will now be described by way of example only, with reference to the accompanying figures in which:

FIG. 1 illustrates an adjustable infant carrier in accordance with the present invention. FIG. 1A depicts a front-side view, FIG. 1B depicts a rear-side view, FIG. 1C depicts a rear view, and FIG. 1D depicts a front-side view of the adjustable infant carrier.

FIG. 2 illustrates an exploded front-side view of the infant carrier illustrated in FIG. 1

FIG. 3 illustrates an exploded cross-sectional side view of the infant carrier illustrated in FIG. 1. The inset image (boxed) illustrates the plane A-A through which the cross-sectional side view is provided. The dashed lines are provided to indicate a magnified portion of the exploded cross-sectional side view, particularly a magnified portion of the support shaft.

FIGS. 4A and 4B illustrate front-side views of plate members comprised in a harness assembly in accordance with the present invention. FIG. 4A illustrates a harness plate member in accordance with the invention. FIG. 4B illustrates a base plate member in accordance with the invention.

FIGS. 4C-4F illustrate various connecting means used in conjunction with the harness plate member illustrated in FIG. 4A, in accordance with the present invention. FIG. 4C illustrates (from left to right) front-side, side and plan views of a connector used to attach harness securing means to the harness plate member, in accordance with the present invention. FIG. 4D illustrates (from left to right) front-side and side views of a secondary connector used to attach shoulder pad securing means to the harness plate member, in accordance with the present invention. FIG. 4E illustrates (from left to right) front-side and side views of a primary connector used to attach shoulder pad securing means the harness plate member, in accordance with the present invention. FIG. 4F illustrates a plan view the primary connector of FIG. 4E and secondary connector of FIG. 4D in a co-operating engaged configuration.

FIG. 5 illustrates cross-sectional views of the infant carrier illustrated in FIG. 1. FIG. 5A illustrates a cross-sectional side view of the releasable locking mechanism in accordance with the present invention. FIG. 5B illustrates an exploded cross-sectional side view of the releasable locking mechanism in accordance with the present invention in. FIG. 5C is the same as FIG. 5B, with the exception it is viewed as a front-side view. The cross-sectional side view for FIGS. 5A, 5B and 5C is provided in the plane A-A, similarly to FIG. 3.

FIG. 6 illustrates cross-sectional side views of the releasable locking mechanism in accordance with the present invention. FIG. 6A shows the releasable locking mechanism locked in a lowermost position. FIG. 6B shows the releasable locking mechanism locked in an intermediate position. FIG. 6C shows the releasable locking mechanism locked in an uppermost position. The cross sectional views in FIGS. 6A-C are provided through the plane indicated in the corresponding figures in FIG. 7A (plane B-B), FIG. 7B (plane C-C), and FIG. 7C (plane D-D). FIG. 6A corresponds to FIG. 7A, FIG. 6B corresponds to FIG. 7B, and FIG. 6C corresponds to FIG. 7C.

FIG. 7 shows front views of an adjustable infant carrier according to the present invention, when the releasable locking mechanism is locked in a lowermost (FIG. 7A), intermediate (FIG. 7B), and uppermost (FIG. 7C) position. FIG. 7A corresponds to FIG. 6A, FIG. 7B corresponds to FIG. 6B, and FIG. 7C corresponds to FIG. 6C.

FIG. 8 illustrates cross-sectional side views of a headrest plate, comprised in a harness assembly in accordance with the present invention. FIG. 8A is a cross-sectional side view of the headrest plate assembly through plane C-C (inset). FIG. 8B is a cross-sectional plan view of the headrest plate assembly through plane B-B (inset).

FIG. 9 illustrates cross sectional side views of a headrest plate, comprised in a harness assembly in accordance with the present invention, and (reversible) connection thereof to the harness assembly. The cross-sectional side view is through plane B-B, similarly to FIG. 8B. FIGS. 9A and 9B show the insertion of a plug portion of the headrest plate into at least one plate member of the harness assembly, in the direction of the indicated arrows. FIG. 9C shows that movement of the headrest plate in the direction of the indicated arrow secures the headrest plate member and locks it in position.

FIG. 10 illustrates an exploded front-side view (FIG. 10A) and an exploded front view (FIG. 10B) of the headrest assembly being inserted into the at least one plate member, similarly to FIG. 9A. The dashed lines in FIG. 10A indicate the projected lateral motion of the plug portions comprised in the headrest plate member (as also shown in FIGS. 9A and 9B).

FIG. 11 illustrates release of the headrest plate from the harness assembly, to remove the headrest plate. FIG. 11A is a cross-sectional side view through plane B-B, similarly to FIG. 8B. FIG. 11B is a cross-sectional plan view of a headrest plate member and at least one plug portion in accordance with the present invention through plane B-B indicated in the inset portion of the FIG. 11C. FIG. 11C is a cross-sectional plan view through plane B-B indicated in the inset portion of the FIG. 11C, wherein the headrest plate member is in situ in the harness assembly.

### DETAILED DESCRIPTION

The infant carrier in accordance with the present invention will now be described in detail, by way of example only, with reference to the accompanying Figures. Those skilled in the art will appreciate that various modifications may be made to the embodiment described below. The scope of protection is defined in the appended claims, which define the essential features of the invention. Additional features described in the detailed description are optional.

The infant carrier according to the present invention is an adjustable infant carrier 2. Within the context of the present invention, adjustable means that the infant carrier is adaptable such that infants of variable ages and sizes may be accommodated in the adjustable infant carrier 2. For instance, the adjustable infant carrier 2 according to the present invention may be adjustable such that it is suitable for use with an infant from 0-36 months old, optionally 0-24 months old. For example, in infant may be from 6-24 months, optionally from 12-24 months old. Advantageously, as the adjustable infant carrier 2 described herein is adjustable, it may be used from birth, removing the need to buy age-specific infant carriers. The adjustable infant carrier may be suitable for attachment to a chassis, for example the chassis of a pushchair.

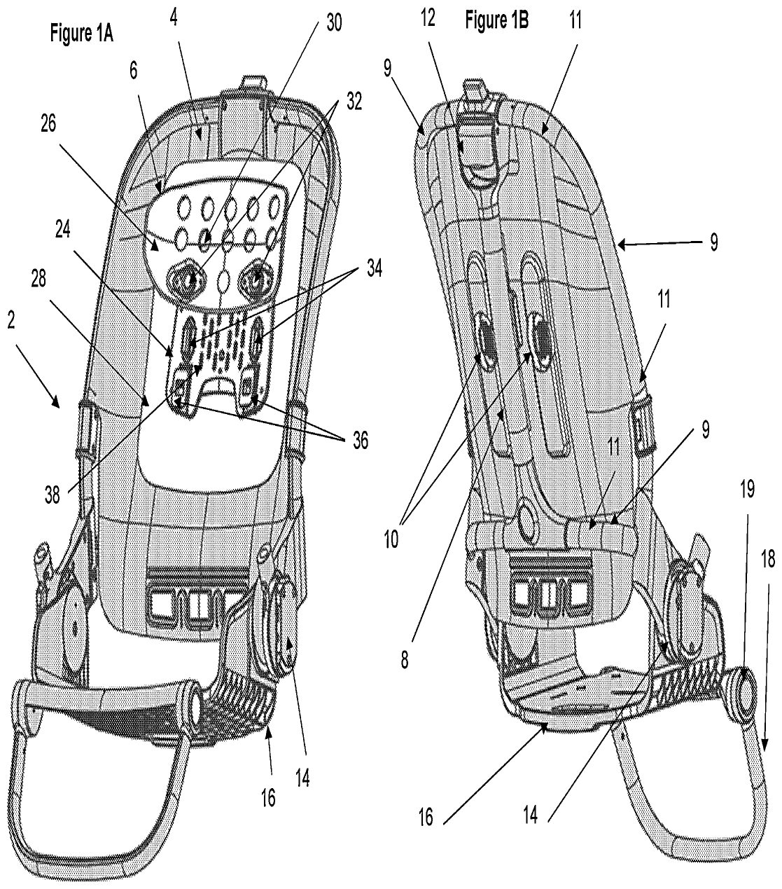

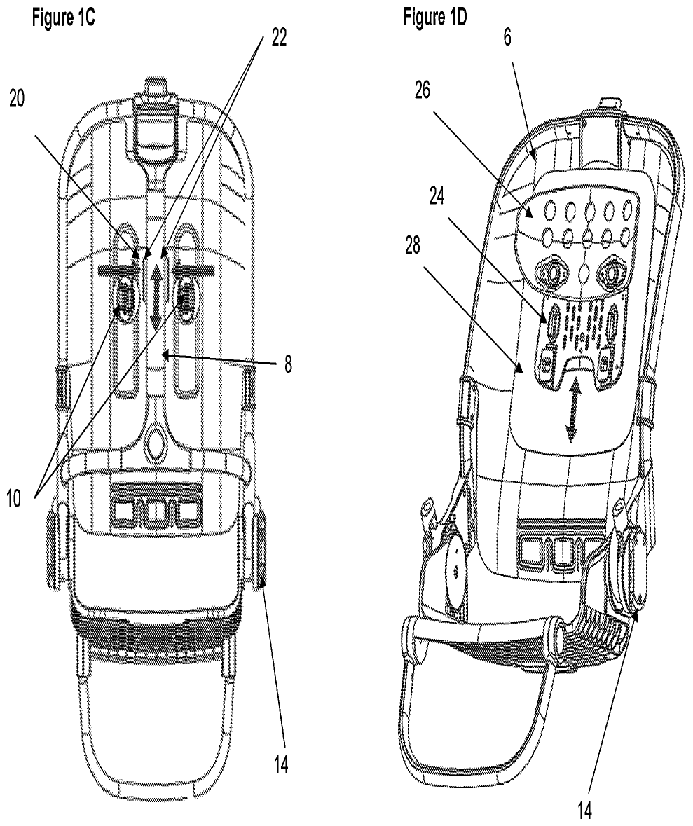

The adjustable infant carrier 2 according to the present invention may have a substantially flat configuration (not illustrated) and a seat configuration (FIGS. 1A-D). The substantially flat configuration is achieved by rotating the backrest 4 relate to the base 16, as described in more detail below. Those skilled in the art will appreciate that the substantially reclined configuration is suitable for use with an infant that is 0-6 months old, where it is recognised the infant should lie as flat as possible to assist in proper skeletal and physical development. As the infant grows, the relative positions of the base 16 and backrest 4 can be adjusted to support the back of the infant so that the infant may sit in a more upright position. As such, the adjustable infant carrier according to the present invention may be an adjustable infant seat. The adjustable infant carrier is optionally provided with a footrest 18, which is rotatable relative to the base member, and optionally may be removed from the adjustable infant carrier if not required.

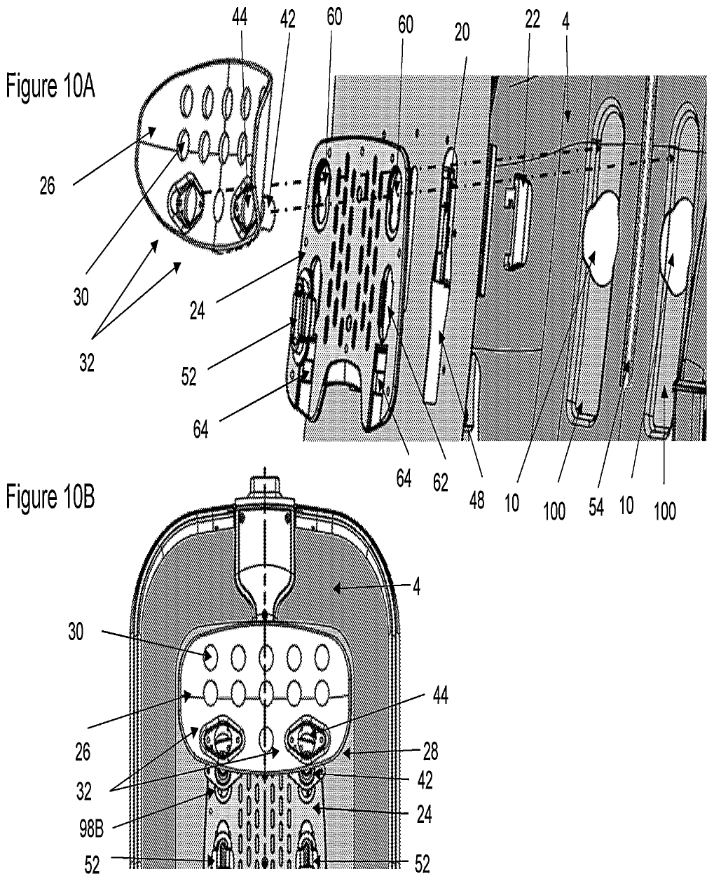

The adjustable infant carrier 2 according to the present invention comprises a backrest 4 having front side (FIG. 1A, FIG. 1D) and a rear (FIG. 1B, FIG. 10) side. The backrest 4 is pivotally connected to a base 16 by pivoting means 14. Pivoting means 14 is configured to allow the backrest 4 and the base 16 to pivot relative to each other, and further includes a locking mechanism (not illustrated) to lock the relative positions of base 16 and backrest 4. The locking mechanism may allow for multiple relative positions of the base 16 and backrest 4 to be locked. The locking mechanism comprised in pivoting means 14 is a releasable locking mechanism, so that the locking mechanism can be released and the relative positions of the base 16 and the backrest 4 can be adjusted if desired. In the illustrated embodiments, a lever 12 is provided to release the locking mechanism, such that pivoting means 14 can rotate (FIG. 1B). The lever 12 is connected to the locking mechanism comprised in pivoting means 14 (not illustrated).

The backrest 4 and base 16 may be positioned in a seat configuration (FIG. 1A, FIG. 1B), or alternatively be positioned such that the backrest 4 and the base 16 are substantially co-planar to provide a flat configuration (not illustrated). Those skilled in the art will appreciate that young infants (e.g. 0-6 months old) should lie flat when sleeping and resting, and so the flat configuration advantageously enables the infant carrier according to the present invention to be suitable for use from birth. Additionally, the backrest 4 and base 16 may rotate relative to each other such that they fold together (not illustrated). Put in other words, the base 16 may fold onto the front side of the backrest 4 or vice versa. This advantageously allows the adjustable infant carrier to be easily stored. As such, pivoting means 14 is configured to allow the base 6 to rotate relative to the backrest through an angle of 1-180°.

Pivoting means 14 (FIGS. 1A-1D) may comprise a housing, configured to allow attachment of the adjustable infant carrier 2 to a chassis e.g. a pushchair chassis. Suitable means for attaching the adjustable infant carrier 2 to a chassis will be apparent to those skilled in the art.

In embodiments, the base 16 is optionally further provided with a foot rest 18, wherein the base 16 and footrest 18 are pivotally connected by pivoting means 19 (FIGS. 1A, 1B). A footrest 18 is particularly advantageous where the adjustable infant carrier is to be used with older infants (e.g. 18 months+). The footrest 18 may be pivotally connected 19 by any suitable means and may comprise a releasable locking mechanism (not illustrated) to secure the position of the footrest 18 relative to the base 16. Those skilled in the art will be aware of suitable pivoting means 19 and releasable locking mechanisms for use in conjunction with the footrest 18. Footrest 18 may be reversibly connected to (i.e. it can be removed from and reattached to) the adjustable infant carrier 2. The footrest 18 pivoting means 19 is configured to allow the base 6 to rotate relative to the footrest 18 through an angle of 1-270°. As such, the position of the footrest 18 can be rotated to suit the position of the infant's legs, and may also be folded towards the base 16 (e.g. folded underneath the base 16) when the infant carrier 2 is folded away to be stored.

The adjustable infant carrier 2 according to the present invention comprises a support shaft 8 arranged on the rear side of the backrest (FIG. 1B, FIG. 1C). The support shaft extends in a longitudinal direction relative to the backrest. That is to say, when the seat is positioned in an upright position (FIGS. 1A-D), the support shaft is arranged vertically relative to the ground. More particularly, the support shaft extends between an upper portion of an outer frame 11 of the backrest, and a lower portion of the outer frame 11 of the backrest, and thus provides support to the structure of the backrest.

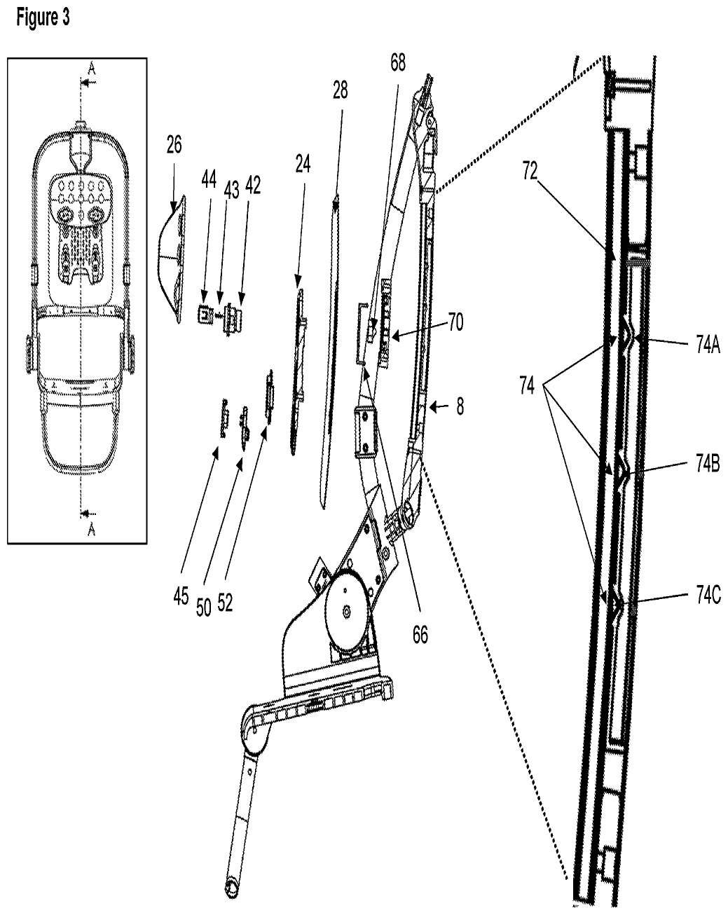

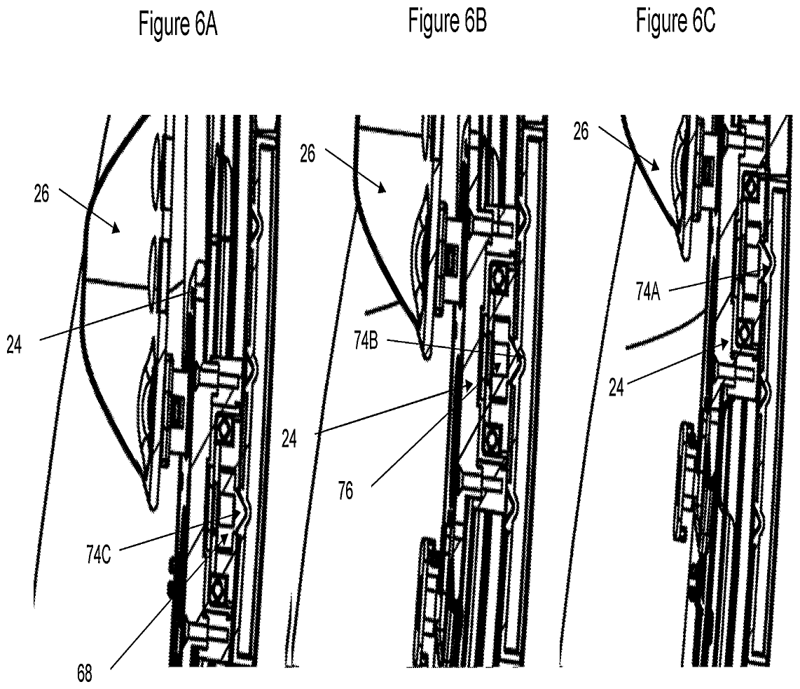

A releasable locking mechanism 20 is at least partially supported by the support shaft 8, as described in more detail below. The support shaft 8 comprises an elongated recess 72 for accommodating at least a portion of the releasable locking mechanism 20 (magnified portion, FIG. 3). The support shaft 8 further comprises a plurality of engagement means 74, for engaging with the releasable locking mechanism 20 (FIG. 3), as described in more detail below. Any suitable engagement means 74 may be used as will be apparent to those skilled in the art. In embodiments, the engagement means 74 are a plurality of recesses which engage with the releasable locking mechanism 20. The support shaft 8 may comprises any number of recesses desired, for example two or more, three or more, four or more, five or more, six or more, and so on. Typically, the support shaft 74 comprises a first recess 74A, a second recess 74B, and a third recess 74C (FIG. 3). Each of the recesses are arranged co-linearly along the length of the support rod (FIG. 3). Each of the recesses are orientated such that the open side of each recess is orientated towards the harness assembly 6 which is arranged on the front side of the backrest (FIG. 3). As described in more detail below, each recess 74A-C (or each engagement means 74) corresponds to a position in which the adjustable harness assembly may be secured (FIG. 6).

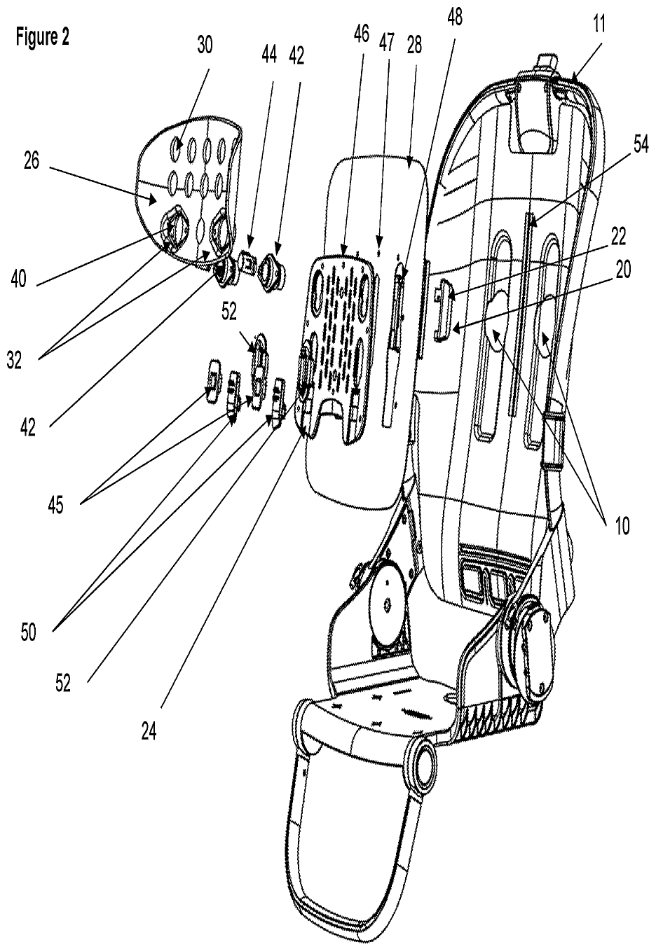

The adjustable infant carrier 2 according to the present invention further comprises an adjustable harness assembly 6 (FIG. 1A), comprising at least one plate member 24, 26, 28 (FIG. 1A, 1D). The harness assembly 6 is arranged on the front side of the backrest 4 (FIG. 1A, 1D; FIG. 2). Slidably moving the releasable locking mechanism 20 relative to the backrest 4 and relative to the support shaft 8 also causes the harness assembly 6 to slidably move relative to the support shaft 8 and relative to the backrest 4 (FIG. 1D, direction of movement indicated by arrows), as described in more detail below.

In embodiments, the adjustable harness assembly 6 comprises a base plate member 28, a harness plate member 24 and a headrest plate member 26 (FIG. 2). Although the embodiments described herein comprise three plate members 24, 26, 28, it will be apparent to those skilled in the art that the benefits of the present invention may also be realised using only a single plate member, alternatively two plate members, or alternatively more than three plate members. The base plate member 28 is optionally provided to shield the user and the infant from moving components of the adjustable harness assembly 6 and releasable locking mechanism 20 (FIG. 2) as described in more detail below. The headrest plate member 26 may be reversibly attachable as described in more detail below. As such the headrest plate member 26 can be changed to adjust the size of the headrest provided depending on the size of the infant. Reversibly attachable means the headrest plate member 26 can be readily attached to the other plate members comprised in the harness assembly 6, and can also be readily removed from the other plate members if desired.

The adjustable infant carrier 2 according to the present invention comprises a releasable locking mechanism 20 (FIG. 10). The releasable locking mechanism 20 is connected to the at least one plate member 24, 26, 28 comprised in the harness assembly 6, and is configured to secure the position of the harness assembly 6 relative to the support shaft 8, and relative to the backrest 4. The releasable locking mechanism 20 is slidably moveable relative to the support shaft 8 and relative to the backrest 4 (FIG. 10, as indicated by the double ended arrow). The releasable locking mechanism 20 is configured to engage with the support shaft 8 to secure the harness assembly 6 in position. More particularly, the releasable locking mechanism 20 is configured to engage with engaging means 74 (e.g. a plurality of recesses such as recesses 74A, 74B, 74C; FIG. 3) to secure the harness assembly 6 in position. The releasable locking mechanism comprises releasing means 22, which when actuated (FIG. 10, inwardly facing arrows indicate imparting force to the releasing means 22) disengages the releasable locking mechanism 20 from engagement with the support shaft 8, enabling slidable movement of the releasable locking mechanism 20 relative to the support shaft 8 and relative to the backrest 8. As the releasable locking mechanism 20 is connected to the at least one plate member 24, 26, 28 of harness assembly 6, movement of the releasable locking mechanism 20 relative to the support shaft 8 and relative to the backrest 4 causes jointly slidable movement of the at least one plate member 24, 26, 28 (FIG. 1D, as indicated by the double ended arrow). The least one plate members 24, 26, 28 are therefore slidably moveable relative to the support shaft and relative to the backrest in unison (i.e. simultaneously). That is to say the base plate member 28, the harness plate member 24 and the headrest plate member 26 do not move relative to each other when slidably moving relative to the support shaft and relative to the backrest, but rather slidably move as a unitary harness assembly 6.

The backrest 4 is provided with an elongated aperture 54 in a longitudinal direction extending from the upper portion of frame 11 towards the base 6 (FIG. 2, FIG. 10A). As described in more detail below, the releasable locking mechanism 20 traverses the elongated aperture 54 to engage with the engaging means 74 provided in the support shaft 8. As such, the elongated aperture 54 at least partially accommodates the releasable locking mechanism 20 (FIG. 2). The elongated recess 72 provided in support shaft 8 also partially accommodates the releasable locking mechanism 20 as described in more detail below (FIG. 3). The elongated aperture 54 and elongated recess 72 may therefore each independently be considered to be guide tracks, for guiding the releasable locking mechanism 20 in its slidable movement relative to the support shaft and relative to the backrest.

The backrest 4 may be provided with at least one, optionally a pair of, aperture(s) 10 accessible from the rear side of the backrest 4 (FIG. 1, FIG. 2). The apertures 10 provide access to the harness assembly 6 comprised in the adjustable infant carrier 2 from the rear side (FIG. 1B) of the infant carrier 2. The at least one aperture 10 can provide access to different portions of the at least one plate member 24, 26, 28 comprised in the harness assembly 6, depending on the position in which the harness assembly 6 is secured relative to the support shaft 8. For instance, the at least one aperture 10 may provide access to the rear side of an upper portion of the at least one plate member 24, 26, 28 when the releasable locking mechanism 20 engages with the lowermost engaging means 74 (e.g. recess 74C; FIG. 6A). The at least one aperture 10 may provide access to the rear side of a middle portion of the at least one plate member 24, 26, 28 when the releasable locking mechanism 20 engages with an intermediate engaging means 74 (e.g. recess 74B; FIG. 6B). Similarly the at least one aperture 10 may provide access to the rear side of a lower portion of the at least one plate member 24, 26, 28 when the releasable locking mechanism 20 engages with the uppermost engaging means 74 (e.g. recess 74A; FIG. 6A). In particular, the at least one aperture 10 can provide access to the rear side of harness plate member 24 comprised in the harness assembly 6, as described in more detail below. In such embodiments, the base plate member 28 comprises elongated apertures 48 so that the rear side of the harness plate member 24 is freely accessible via apertures 10.

Those skilled in the art will appreciate that the present invention requires at least one plate member. The at least one plate member may be considered to be the harness plate member 24 as described herein. As mentioned above, in the illustrated embodiments, the adjustable infant carrier 2 comprises a harness assembly 6, which comprises a harness plate member 24, a base plate member 28, and a headrest plate member 26 which optionally is reversibly attachable to one or more of the further base plate members comprised in the harness assembly 6. Features of each of the base plate member 28, harness plate member 24, and headrest plate member will now be described in more detail below.

The harness plate member 24 is provided to secure the harness straps to the harness assembly 6, and optionally to secure shoulder pads to the harness assembly 6. Optionally, the headrest plate member 26 is provided to provide support to the head of the infant. Optionally, the base plate is provided to screen the moveable components of the adjustable harness assembly 6 and the releasable locking mechanism 20, for instance to avoid the infant getting their fingers trapped therein.

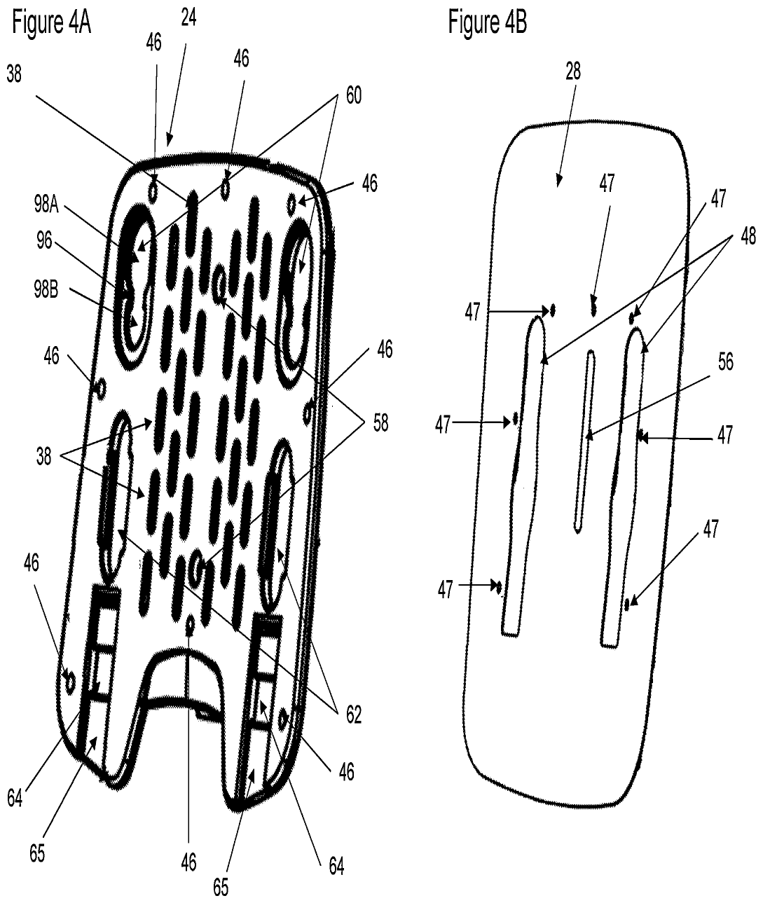

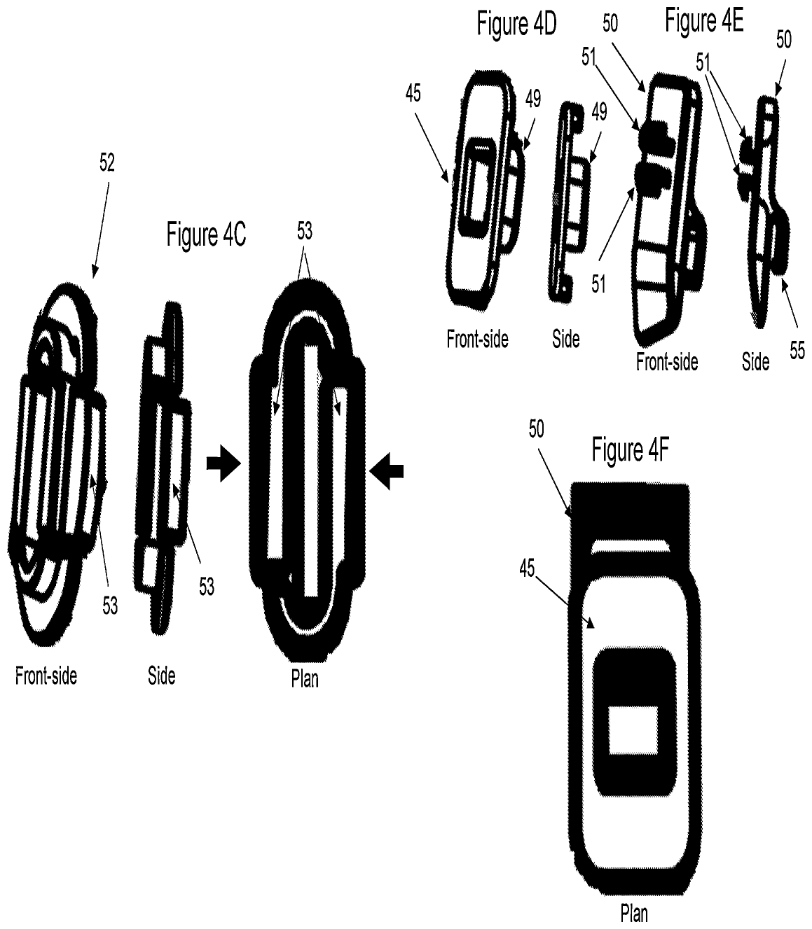

In the illustrated embodiments, the harness plate member 24 is positioned between the base plate member 28 and the headrest plate member 26 (FIG. 1A, FIG. 1D, FIG. 2). The harness plate member 24 is secured to the base plate member 28 (FIG. 1A, 1D; FIG. 4A, 4B). Suitable means of securing the harness plate member 24 to the base plate member 28 will be apparent to those skilled in the art. In embodiments, the harness plate member 24 comprises a plurality of fastening apertures 46 (FIG. 4A), and the base plate member 28 comprises a plurality of corresponding fastening apertures 47 (FIG. 4B), such that when the harness plate member 24 is positioned onto the base plate member 28, each fastening aperture 46 of the harness plate member 24 is aligned with a corresponding fastening aperture 47 of the base plate member 28 (FIG. 2; FIG. 4A, 4B). The fastening apertures 46 of the harness plate member 24 and corresponding fastening apertures 47 of the base plate member 28 may be secured together by means of rivets, screws and the like.

The harness plate member 24 comprises a pair of apertures 62 (FIG. 4A) for securing harness securing means 34 (FIG. 1A). Those skilled in the art will appreciate that the pair of apertures 62 are spaced apart at a distance that is suitable to accommodate the upper body of an infant. The harness securing means 34 comprises at least one connector 52 (FIGS. 2, 3, 4C), wherein each connector 52 engages with an aperture 62 (FIG. 4A). The connector 52 is connected to harness straps. The apertures 62 and connector 52 fit together by means of a snap-fit arrangement. The connector 52 is elongated, and comprise a pair of flanges 53 along its longitudinal sides (FIG. 4C illustrating front-side, side and plan views of a connector 52). The connector 52 is additionally resiliently deformable, such that pushing the flanges 53 towards each other (direction of indicated arrows, FIG. 4C), causes the connector 52 to disengage from aperture 62. Advantageously, the connector 52 and the flanges 53 thereof are accessible at the rear of the harness plate member 24 via apertures 10 in the backrest 4. For instance, the connector 52 may be accessible when the releasable locking mechanism is secured in an intermediate position (e.g. the releasable locking mechanism engaged with recess 74B; FIG. 6B). Having the connector 52 accessible at the rear of the infant seat means the infant cannot inadvertently tamper with the harness. Moreover, as the connector 52 is elongated, it may be passed through aperture 62 from the rear side of the harness plate member 24 to the front side of the harness plate member 24. Advantageously, the harness can thus be removed for cleaning if desired. The apertures 62 provide a recess in which the connector 52 of the harness securing means 34 can be accommodated. Advantageously, the harness securing means 34 thus lies flush with the front face of the harness plate member 24. This means no discomfort is caused to the infant, as the harness plate member 24 is free of surface protrusions which could contact the back of the infant.

The harness plate member 24 further optionally comprises a pair of apertures 64 (FIG. 4A) for securing shoulder pad securing means 36 (FIG. 1A). Those skilled in the art will appreciate that the pair of apertures 64 are spaced apart at a distance that is suitable to accommodate the upper body of an infant. Any suitable means may be used to secure the shoulder pad securing means 36 to the apertures 64 of the harness plate member 24 may be provided. In the illustrated embodiments, shoulder pad securing means 36 comprises a primary connector 50 and a supplementary connector 45 (FIG. 2, FIGS. 4C-D). Supplementary connector comprises at least one rib 49 (FIG. 4D) which clips onto flanges 51 (FIG. 4E) provided on the front side of primary connector 50 in a snap-fit arrangement (as shown in FIG. 4F). The primary connector 50 further comprises a lip 55 (FIG. 4E), which engages with apertures 64 (FIG. 4A) to secure the shoulder pad securing means 36 to the harness plate member 24. The apertures 64 occupy an elongated recess 65 in the forward face of the harness plate member 24, wherein the secondary 45 and primary 50 connectors of the shoulder pad securing means 36 can be accommodated (FIG. 4A). Advantageously, the shoulder pad securing means 36 thus lies flush with the front face of the harness plate member 24. This means no discomfort is caused to the infant, as the harness plate member 24 is free of surface protrusions which could contact the back of the infant.

Preferably the apertures 64 for receiving should pad securing means are below the apertures 62 for receiving harness securing means 34. As the shoulder pads are preferably resiliently deformable (e.g. made of foam, sponge or other suitable material), the provision of shoulder pads can advantageously provide structure and support to the harness straps (not illustrated), making it easier for the user to put the harness on the infant, and take them out of the harness.

The harness plate member 24 further comprises a plurality of apertures 38 to advantageously reduce the overall weight of the harness plate member 24 (FIG. 1A, FIG. 4A).

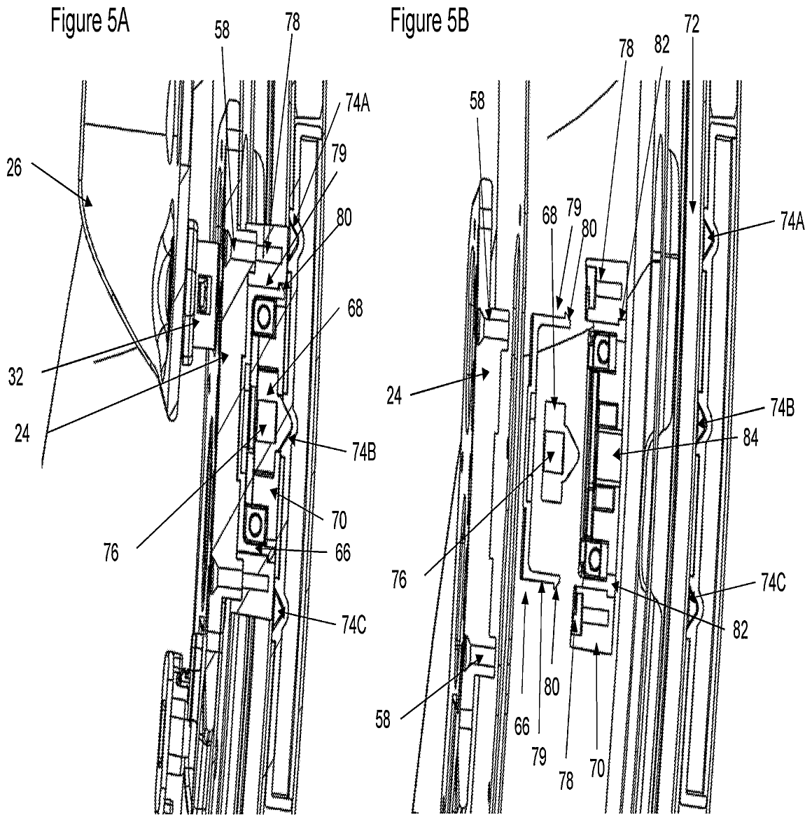

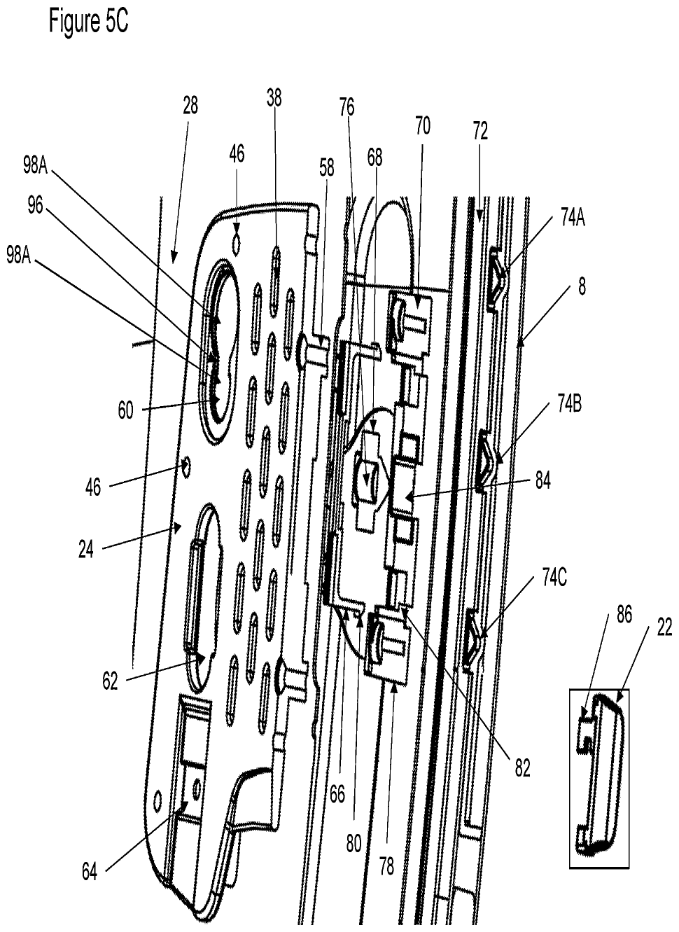

The at least one plate member is connected to the releasable locking mechanism 20. In the illustrated embodiments, the harness plate member 24 is connected to the releasable locking mechanism 20. Suitable means of connecting the releasable locking mechanism 20 to the at least one plate member of the harness assembly 6 will be apparent to those skilled in the art. In embodiments, the harness plate member 24 comprises fastening apertures 58 (FIG. 4A), which can be secured to corresponding fastening recesses 78 provided in the releasable locking mechanism 20 (FIG. 5A, 5B). More particularly, the fastening recesses 78 can be provided in a housing 70 of the releasable locking mechanism 20 (FIG. 5A, 5B). The fastening apertures 58 and corresponding fastening recesses 78 may be secured together by means of rivets, screws, and the like.

As described above, the harness plate member 24 can be connected to the base plate member 28, for example by means of rivets, screws and the like via apertures 46, 47. In such embodiments, the base plate member 28 comprises elongated apertures 48 (FIG. 2, FIG. 4B). Elongated apertures 48 allow access to the rear side of the harness plate member 24 via apertures 10 in the backrest 4, as described above.

The releasable locking mechanism 20 is connected to the at least one plate member comprised in the harness assembly. In embodiments, the harness plate member 24 is connected to the releasable locking mechanism 20. In such embodiments, the base plate member 28 comprises an elongated aperture 56 (FIG. 4B), which at least partially accommodates the releasable locking mechanism 20 to allow the slidably moveable motion of the releasable locking mechanism 20 relative to the support shaft 8 and the backrest 4. The elongated aperture 56 of the base plate member 28 (FIG. 4B) substantially overlaps with the elongated aperture 54 provided in the backrest 4 (FIG. 2).

The harness plate member 24 further comprises apertures 60 for receiving the headrest plate assembly (FIG. 4A). Apertures 60 are configured to engage with the reversible connecting mechanism 32 of the reversibly connectable headrest plate member 26 to secure the headrest plate member 26 in position, as described in more detail below. The apertures 60 comprise an upper portion 98A and a lower portion 98B (FIG. 4A). The lower portion 98B is smaller than the upper portion 98A. The lower portion 98B and upper portion 98A may represent overlapping circles, where the diameter of the lower portion 98B is less than the diameter of the upper portion 98B. Between the upper portion 98A and the lower portion 98B, there is provided a locking protrusion 96, also referred to herein as lip 96. The lip 96 engages with the reversible connecting mechanism 32 of the reversibly connectable headrest plate member 24, as described in more detail below (FIG. 4A, FIG. 10A, 10B).

The headrest plate member 26 is optionally reversibly attachable to the harness plate member 24. In embodiments described herein, the headrest plate member is reversibly attachable, but those skilled in the art will appreciate that the headrest plate member may be fixed to the harness plate member 24 in alternative embodiments.

In the illustrated embodiments, the headrest plate member 26 comprises a series of apertures 30 (FIG. 1A, FIG. 10A) which advantageously reduces the overall weight of the headrest plate member. The headrest plate member 26 may also comprise outwardly extending side portions, such that the head of the infant is at least partially surrounded by the headrest plate member 26. Advantageously this arrangement keeps the head of the infant secure. Alternatively, the headrest plate member may represent an infant nest, and as such can advantageously substantially surround the entire body of the infant. Such headrest plate members 26 are advantageous where the adjustable infant seat 2 according to the invention is in a flat configuration for use with an infant from 0-12 months old. Those skilled in the art will appreciate that infant nests are typically comprise soft upstanding peripheral walls to cushion the infant therein. The headrest plate member 26 may therefore be considered to be an accessory, which can be changed as desired by the user. As the infant grows from birth, a headrest which is more suitable for an infant that is between 6-12 months may be provided for instance.

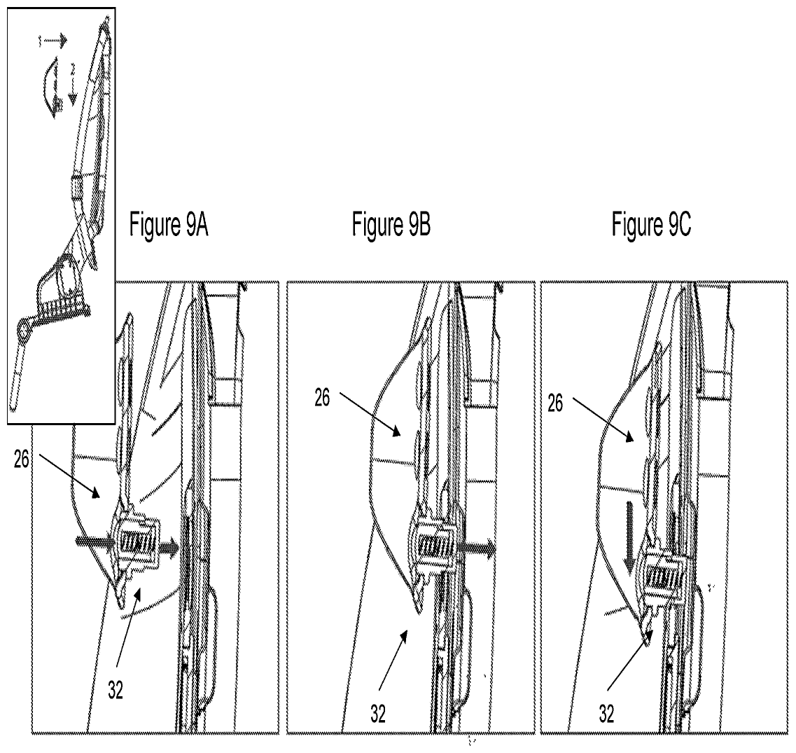

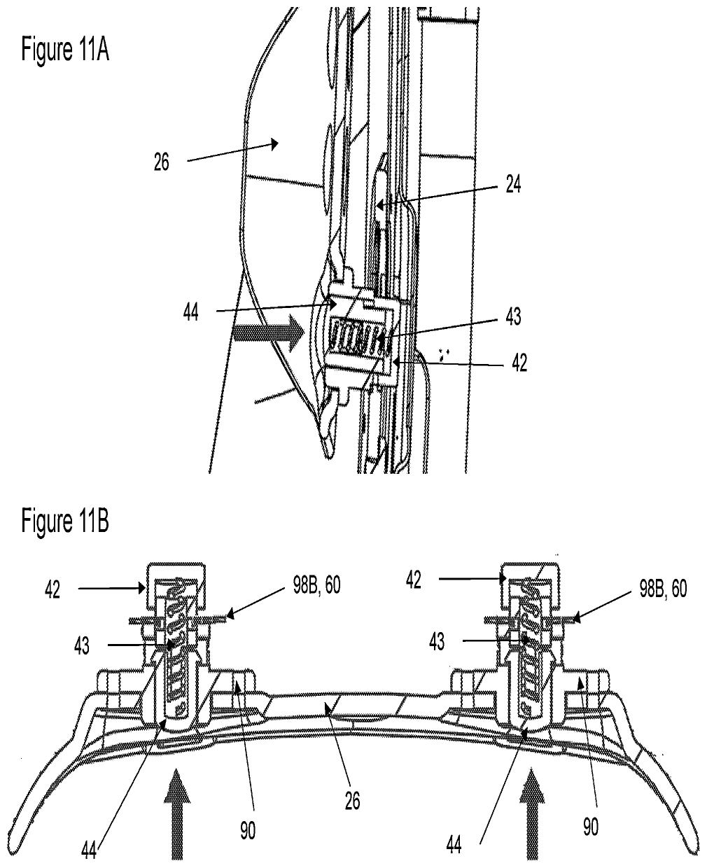

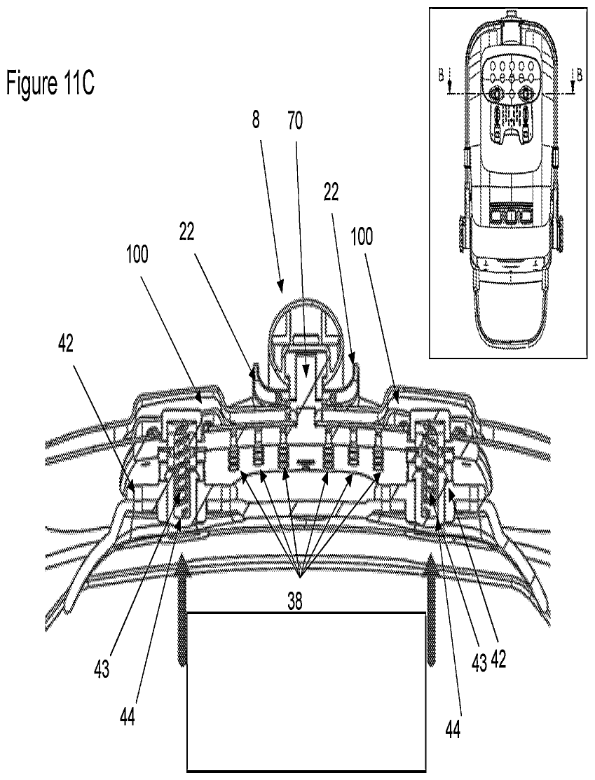

The headrest plate member 26 is reversibly attachable to the harness assembly 6, and more particularly to the harness plate member 24 (which is optionally connected to the base plate member 28). The headrest plate member 26 comprises a reversible connecting mechanism 32 for reversibly attaching the headrest plate member (FIG. 1A, FIG. 9, FIG. 11). Various reversible connecting mechanisms 32 suitable for attaching the headrest plate member 26 to the harness assembly 6 will be apparent to those skilled in the art (e.g. hook and eye arrangements [e.g. Velcro]). In embodiments of the present invention, the headrest plate member 26 is reversibly attachable to the harness assembly 6 by means of a plug and socket type arrangement, which is described in more detail below. The headrest plate member 26 may comprise a pair of recessed apertures 40 for accommodating the connecting mechanism 32 (FIG. 2). Advantageously, the recessed apertures 40 means the connecting mechanism 32 lies substantially flush with the front face of the headrest plate member 26, thus avoiding discomfort to the infant (FIG. 2).

In embodiments, the headrest plate member 26 comprises at least one plug portion. The one or more further plate members (e.g. the harness plate member 24, and optionally the base plate member 28) provide at least one socket portion configured to receive the plug portion. The at least one plug portion and the at least one socket portion collectively comprise the reversible connecting mechanism 32. Although the headrest plate member 26 comprising at least one plug portion and the one or more further plate members comprising at least one socket portion is described herein with reference to the illustrated embodiments, those skilled in the art will appreciate that the inverse relationship is equally encompassed within the present invention. Preferably, the headrest comprises a pair of plug portions, and the one or more further plate members comprise a pair of corresponding socket portions configured to receive the pair of plug portions. The plug and socket type arrangement allows the headrest plate member 26 to be reversibly secured to the one or more further plate members, and thus to the harness assembly 6.

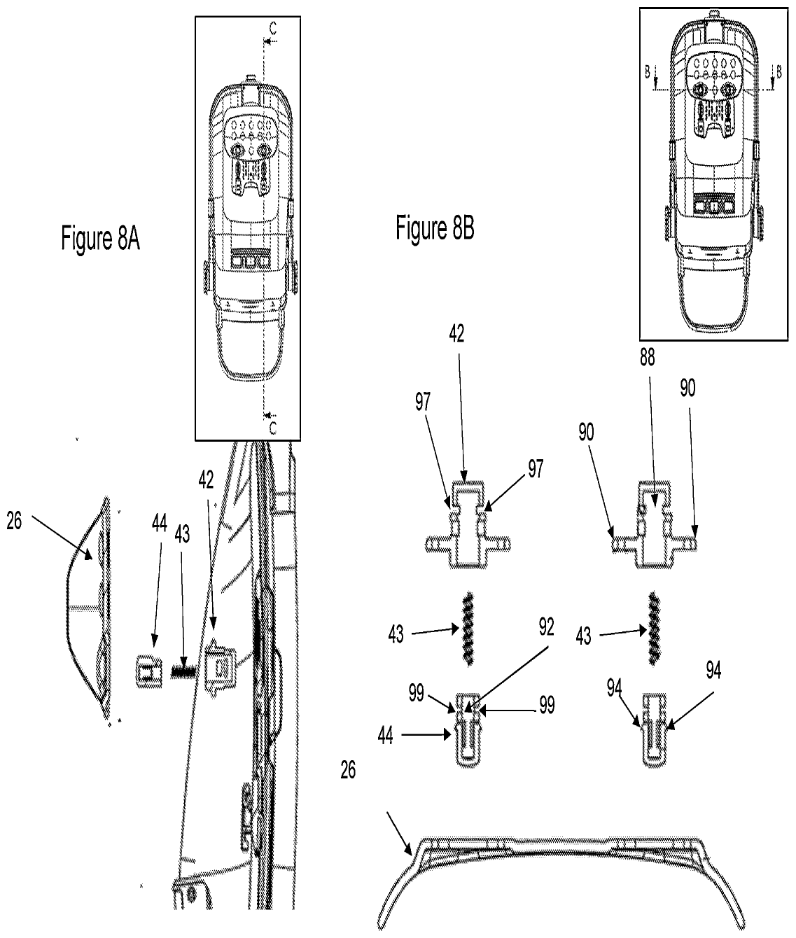

In embodiments, the headrest plate member 26 comprises at least one plug portion, each plug portion comprising a female member 42, a biasing means 43, and a male member 44 (FIGS. 8A, 8B; FIG. 2; FIG. 3). The female member 42 comprises at least one flange 90, preferably a pair of flanges, for securing the female member 42 (and thus the plug portion) to the headrest plate member 26. Suitable means for attaching the female member 42 to the headrest plate member 26 will be apparent to those skilled in the art, but may include screws, rivets and the like.

The male portion comprises a recess 92, in which the biasing means 43 is positioned. The male member is then inserted into the female member 42, such that the biasing means 43 is positioned between the male member 44 and the female member 42. The male member 44 is secured within the female member 42 in recess 88 by means of outwardly protruding lips 94. Lips 94 engage with corresponding recesses 95 provided on the inside surface of the female member 42 (FIG. 8B). The corresponding recesses 95 are configured to allow the male member 44 to be slidably moveable within the recess 88 of the female member 42. As such, the male member 44 may be slidably moved towards the female member 42, such that the biasing means 43 is compressed, into a compressed configuration. In such a compressed configuration, indentations 97 provided on the female member align with indentations 99 provided on the male member. Upon alignment of indentations 97, 99, the reversible connecting mechanism 32 is in a releasing configuration (or releasing position), and the headrest plate member 26 can be removed from the harness assembly 6.

Upon release of the male member 44, the biasing means 43 urges the male member 44 to return to a resting position within the female member 42. The indentations 97, 99 are thus biased away from an aligned configuration, to provide a locking configuration in which the headrest plate member 26 is secured to the harness assembly 6.

The at least one plug portion of the headrest plate member 26 is secured to the harness assembly via insertion into the apertures 60 provided in the harness plate member 24 (FIG. 4A). The base plate member 28 comprises elongated apertures 48 which allows the plug portion to also traverse the base plate member 28 (FIG. 4B). Additionally, the backrest 4 may comprise elongated recesses 100, which are configured to at least partially accommodate the plug portion (FIG. 10A). The elongated recesses 100 ensure that the harness plate assembly 6 can slidably move relative to the support shaft 8 and the backrest 4 when a headrest plate member 26 comprising at least one plug portion is inserted (FIG. 10A).

At least one of the female members 42 or at least one of the male members may comprises a cam surface (not illustrated). In use, the headrest plate member 26 (and more particularly the at least one plug portion thereof) is inserted into the harness plate member 24 via apertures 60 (FIG. 4A, FIG. 9A). The headrest plate member 26 is inserted into the upper portion 98A of aperture 60, traverses the base plate member 28 via apertures 48 and protrudes into the elongated recess 100 of the backrest 4 (FIG. 4A, FIG. 9B). The headrest plate member 26 (and more particularly the at least one plug portion thereof) is then slidably moved from the upper portion 98A of aperture 60 into the smaller, lower portion 98B (FIG. 4A, FIG. 9C). Slidable movement of the headrest plate member 26 from the upper portion 98A into the lower portion 98B causes the cam surface to engage with the lip 96 provided in aperture 60. Engagement of lip 60 with the cam surface urges the indentations 97, 99 into an aligned position (the releasing configuration) such that the at least one plug portion can pass freely into the lower portion 98B of aperture 60. Once the at least one plug portion passes into the lower portion 98B, the biasing means 43 urges the male member 44 and the female member 42 apart such that the indentations 97, 99 are no longer aligned (the locking configuration).

In the locking configuration, the periphery of the lower portion 98B extends into the indentations 99 of the male member 44, and becomes pinned between the male member 44 and the female member 42 (FIG. 11B). Slidably moving the male member 44 relative to the female member 42 in the direction of the biasing means 43 provides the releasing configuration, and causes indentations 97, 99 to align (direction of the indicated arrows, FIGS. 11A, 11B, 11C). Once indentations 97, 99 are aligned, the periphery of the lower portion 98B of apertures 60 is released, and the headrest plate member 26 can be slidably moved up into the upper portion 98A and removed from the harness assembly 6.

The biasing means may be any suitable resiliently deformable member, but is preferably a spring. Those skilled in the art will appreciate resiliently deformable means able to be deformed from a resting configuration into a deformed configuration in response to an applied force, which is then able to return to the resting configuration when said applied force is removed.

As described above, the harness assembly 6 comprises at least one plate member, wherein the at least one plate member is connected to the releasable locking mechanism 20. In embodiments, the releasable locking mechanism 20 is connected to the harness plate member 24.

The releasable locking mechanism 20 comprises a releasable locking mechanism housing 70 (FIG. 5B). The releasable locking mechanism housing comprises recesses 78, which correspond to apertures 58 provided in the harness plate member, such that the harness plate member 24 and the locking mechanism housing 70 can be secured together (e.g. by means of screws, rivets and the like). The releasable locking mechanism further comprises a housing capping member 66. The housing capping member 66 comprises a pair of arms 79 which terminate in lips 80. The releasable locking mechanism housing 70 comprises recesses 82, which have a complimentary shape to the arms 79 such that the lips 80 engage with the recesses 82 to secure the housing capping member 66 and the releasable locking member housing 70 together (FIG. 5A, FIG. 5B). The capping member 66 and housing 70 may therefore be secured together by means of a snap-fit arrangement.

The releasable locking mechanism 20 is positioned between the at least one plate member (e.g. the harness plate member 24) and the support shaft 8. This arrangement retains the releasable locking mechanism in the slidably moveable arrangement relative to the support shaft 8 and the backrest 4. In embodiments, the releasable locking mechanism is connected to the support shaft 8. The releasable locking mechanism may be at least partially accommodated in an elongated recess 72 provided in the support shaft 8 (FIG. 3). More particularly, at least a portion of the locking mechanism housing may have a complimentary shape to the elongated recess 72 (FIG. 11C, complimentary cross sections are illustrated) such that the locking mechanism housing is retained within the elongated recess 72, and is slidably moveable within the elongated recess. The elongated recess 72 may therefore function as a guide track for guiding the slidable motion of the releasable locking mechanism 20 relative to the support shaft 8 and the backrest 4.

As previously described, the backrest 4 may be provided with an elongated aperture 54 which is traversed by the releasable locking mechanism 20. As such, the elongated aperture 54 may also function as a guide track for guiding the slidable motion of the releasable locking mechanism 20 relative to the support shaft 8 and the backrest 4.

The base plate member 28 may also be provided with an elongated aperture 56, which is traversed by the releasable locking mechanism. As such, the elongated aperture 56, the elongated aperture 54, and the elongated recess 72 preferably substantially overlap.

The releasable locking mechanism is further provided with a locking member 68, which may for instance be a locking pin, configured to engage with the support shaft 8. The locking member 68 is positioned between the capping member 66 and the releasable locking mechanism housing 70 in a correspondingly shaped recess 84 (FIG. 5B, FIG. 5C). The locking member 68 comprises a recess 76 in which a biasing member is positioned. The biasing member urges the locking member 68 towards the support shaft 8 to provide a locking position. The releasing means 22 is actuated, such that the locking member 68 is urged away from the support shaft 8, causing biasing means to be compressed and the locking member to disengage with the support shaft to provide a releasing position (FIG. 10, FIG. 11C). The releasing means 22 may comprise a flange 86 which causes the locking member 68 to be urged away from engagement with the engagement means 74 of the support shaft 8 (FIG. 5C). In the releasing position, the releasable locking mechanism can be slidably moved relative to the support shaft 8 and relative to the backrest 4, so that the harness assembly and the releasable locking mechanism can be adjusted (FIG. 10, movement in direction of indicated arrows).

As described above, the support shaft comprises a plurality of engagement means 74, which may be a plurality of recesses, arranged to face towards the harness assembly 6. The plurality of engagement means 74 are configured to engage with the releasable locking mechanism 20, and more particularly with locking member 68 described above, to secure the position of the harness assembly relative to the support shaft and relative to the backrest.

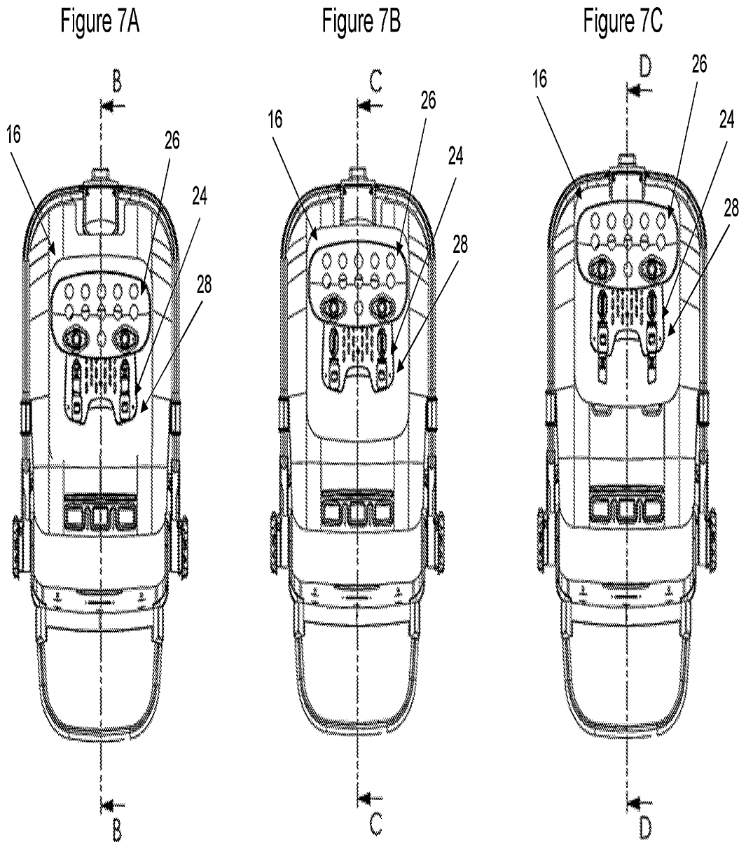

The locking member 68 is configured to engage with a single engagement means 74 (e.g. a recess) comprised in engagement means 74, but as the releasable locking mechanism is slidably moveable relative to the support shaft 8, the locking member 68 may engage with any of the engagement means 74 provided on the support shaft 8. In this way, the position of the releasable locking mechanism relative to the support shaft 8, and thus the position of the at least one plate member (e.g. the harness plate member 24) comprised in the harness assembly 6 can be adjusted. For instance, the locking member 68 may engage with a lowermost recess 74C (FIG. 6A, FIG. 7A) such that the at least one plate member of the harness assembly 6 is in the lowest position; the locking member 68 may engage with an intermediate recess 74B such that the at least one plate member of the harness assembly 6 is in an intermediate position (FIG. 6A, 7B), and the locking member 68 may engage with an uppermost recess 74C such that the at least one plate member of the harness assembly 6 is in an uppermost position.

In embodiments, when in the harness assembly 6 is in the lowermost position, a rear portion of the harness plate member which corresponds to the position of the reversible connecting mechanism 32 of the headrest plate member 26 may be accessible via apertures 10 in the backrest 4.

In embodiments, when in the harness assembly 6 is in an intermediate position, a rear portion of the harness plate member, which corresponds to the position of the harness securing means 34, may be accessible via apertures 10 in the backrest 4. As such, the harness securing means 34 is also accessible, such that connector 52 may be removed from apertures 62 allowing the harness to be removed from the harness plate member 24.

In embodiments, when in the harness assembly 6 is in an uppermost position, a rear portion of the harness plate member, which corresponds to the position of the shoulder pad securing means 36, may be accessible via apertures 10 in the backrest 4. As such, the shoulder pad securing means 36 is also accessible, such that one or both of secondary 45 and primary 50 connectors may be removed from apertures 64 allowing the shoulder pads to be removed from the harness plate member 24.

In a further aspect of the present invention, there is also provided a reversibly attachable headrest comprising a plug portion as described above.

1. An adjustable infant carrier comprising:
a backrest for supporting the upper body of an infant, the backrest having a front side and a rear side;
a support shaft arranged at the rear side of the backrest;
a harness assembly comprising at least one plate member arranged on the front side of the backrest; and
a releasable locking mechanism positioned between the at least one plate member and the support shaft, the releasable locking mechanism being connected to the at least one plate member and being configured to secure the position of the harness assembly relative to the support shaft and relative to the backrest; and
wherein the at least one plate member and releasable locking mechanism are jointly slidably moveable relative to the support shaft and relative to the backrest.

2. An adjustable infant carrier according to claim 1, wherein the backrest comprises at least one elongated aperture, wherein the releasable locking mechanism is slidably arranged in the at least one elongated aperture, optionally wherein the releasable locking mechanism at least partially traverses the elongated aperture.

3. An adjustable infant carrier according to claim 1, wherein the support shaft comprises an elongated recess, wherein the releasable locking mechanism is slidably arranged in the elongated recess.

4. An adjustable infant carrier according claim 1, wherein the support shaft comprises a plurality of engagement means arranged along the length of the support shaft, optionally wherein the engagement means face the rear side of the back rest, optionally wherein each engagement means corresponds to a position in which the harness assembly may be secured by the releasable locking mechanism, optionally wherein the each engagement means is a recess.

5. An adjustable infant carrier according to claim 4, wherein the releasable locking mechanism comprises at least one locking member, wherein the at least one locking member is configured to engage with at least one of the plurality of engagement means, optionally wherein the at least one locking member has a complementary shape to each of the engagement means, optionally wherein the at least one locking member is a locking pin.

6. An adjustable infant carrier according to claim 1, wherein the releasable locking mechanism further comprises a locking mechanism housing, optionally wherein the locking mechanism housing is connected to the at least one plate member.

7. An adjustable infant carrier according to claim 1, wherein the releasable locking mechanism further comprises a locking release, wherein actuation of the locking release allows slidable movement of the releasable locking mechanism relative to the support shaft and relative to the backrest.

8. An adjustable infant carrier according to claim 1, wherein the at least one plate member comprises a harness plate member for securing a harness to the infant seat.

9. An adjustable infant carrier according to claim 1, wherein the at least one plate member comprises a headrest plate member for supporting the head of an infant, optionally wherein the headrest plate is reversibly connected to the infant seat.

10. An adjustable infant carrier according to claim 9, wherein the headrest plate is reversibly connected to the infant seat by means of a plug and socket arrangement.

11. An adjustable infant carrier according to claim 10, wherein the headrest plate comprises at least one plug portion.

12. An adjustable infant carrier according claim 11, wherein the at least one plug portion comprises a female member, a biasing member, and a male member, wherein the male member comprises a recess such that the biasing member can be accommodated therein.

13. An adjustable infant carrier according to claim 12, wherein the biasing means biases the male member within the female member into a locking position, and wherein relative movement between the male member and the female member against the biasing member provides a releasing position.

14. An adjustable infant carrier according to claim 12, wherein the male member comprises a cam surface.

15. An adjustable infant carrier according to claim 10, wherein the plug portion comprises a release button, to allow the headrest plate to be removed.

16. An adjustable infant carrier according to claim 10, wherein the seat unit comprises at least one socket portion, wherein the at least one socket portion comprises an asymmetrical aperture, optionally wherein the asymmetrical aperture comprises an upper portion and a lower portion, wherein the upper portion is larger than the lower portion, optionally wherein in use, the at least one plug portion is inserted into the upper portion, and is then slidably moved into engagement with the lower portion, optionally wherein the lower portion comprises a locking protrusion, for engaging with the at least one plug portion of the headrest plate to lock the headrest plate in position.

17. An adjustable infant carrier according to claim 16, wherein the at least one socket portion transverses at least one further plate comprised in the harness assembly.

18. An adjustable infant carrier according to claim 16, wherein the at least one socket portion extends into the backrest, wherein the backrest comprises a recess for accommodating the at least one socket portion.

19. An adjustable infant carrier according to claim 1, wherein the at least one plate member comprises a base plate for supporting one or more further plate members.

20. An adjustable infant carrier according to claim 1, wherein the at least one plate member comprises:
a base plate member;
a harness plate member for supporting harness straps for securing an infant to the seat, the harness plate member being arranged on the base plate member; and
a reversibly connectable headrest plate member for supporting the head of an infant, the headrest plate member being reversibly attachable to at least the harness plate member.

21. An adjustable infant carrier according to claim 1, wherein the backrest comprises at least one aperture, the at least one aperture providing access the harness assembly from the rear side of the backrest.

22. A headrest plate member for use with an infant carrier, wherein the headrest plate member is reversibly connectable to the infant carrier by means of a plug and socket arrangement, and comprises at least one plug portion, wherein the at least one plug portion comprises a female member, a biasing member, and a male member, wherein the male member comprises a recess such that the biasing member can be accommodated therein, optionally wherein the headrest plate member is as defined in claim 14.

23. A headrest plate member suitable for use with an infant carrier according to claim 1.
